(19) United States
(12) Patent Application Publication
(10) Pub. No.: US 2012/0326352 A1
(43) Pub. Date: Dec. 27, 2012

(54) METHOD FOR THE INJECTION MOULDING OF PLASTIC PARTS FROM THERMOPLASTIC MATERIAL

(75) Inventor: Helmut ECKARDT, Meinerzhagen (DE)

(73) Assignee: WITTMANN BATTENFELD GMBH, Kottingbrunn (AT)

(21) Appl. No.: 13/527,232

(22) Filed: Jun. 19, 2012

(30) Foreign Application Priority Data
Jun. 24, 2011 (DE) 10 2011 105 775.0

(51) Int. Cl. B29C 45/00; B29C 45/14; B29C 45/73

(52) U.S. Cl. 264/257; 264/328.16; 264/259

(57) ABSTRACT

The invention relates to a method for the injection moulding of plastic parts from thermoplastic material. To produce stable plastic parts with a low density, the method comprises the steps:
a) Production of thermoplastic melt;
b) Adding of a fluid to the thermoplastic melt;
c) Mixing of the thermoplastic melt containing the fluid;
d) Providing of an injection moulding tool with a cavity, wherein the volume of the cavity of the injection moulding tool is expandable from an initial volume to an end volume;
e) Heating of at least a part of the walls of the cavity;
f) Injection of the mixture from thermoplastic melt and gas into the cavity, wherein the volume of the cavity takes the initial volume;
g) Expansion of the volume of the cavity;
h) Cooling of at least a part of the walls (9) of the cavity;
i) Demoulding of the injection moulded plastic part after the plastic melt is at least partially solidified.

The invention relates to a method for the injection moulding of plastic parts from thermoplastic material.

Such a method is known for example from DE 198 48 151 A1. The structural foam injection moulding is used here with physical gas injection of the melt for the construction of plastic parts from thermoplastic melt. At this method a melt with injected fluid is injected into the cavity of an injection moulding tool. The gas pressure presses the melt against the cavity walls during cooling, so that the cooling-conditioned volume contractions can be balanced and the part surface is free from sink marks.

Hereby beneficially foamed parts can be produced with a compact skin and a foamed core. Particularly it is beneficial at the present application of a physical blowing agent (fluid, particularly gas) that a higher gas pressure can be built than by using of a chemical blowing agent, to be able to process well higher viscose plastic materials and to produce parts with less wall size. So, a consistent distribution of the gas takes place within the melt.

If high-strength and bending resistant parts with less weight shall be produced, the previous known method is not optimal, as they are particularly enquired increasingly in the area of the automobile industry. Reductions of density at the structure foam are only possible within limited dimensions with the previous known methods. With wall sizes of approx. 2.5 mm reductions of density will be obtained in the area of approx. 5% to 10%. Bigger reductions of density cause an aggravation of the mechanical characteristics. With wall sizes of 5 mm reductions of density are reasonably possible of approx. 10% to 20%.

At foamed parts a reduction of density cause always also an aggravation of the mechanical characteristics, i. e. particularly the stabilities. Furthermore the surface of the parts can degrade essentially; so-called silver flow marks often occur on the surface.

It is possible indeed to reduce the mentioned building of the flow marks or to prevent it completely by namely establishing for example a gas counter pressure within the tool which is bigger than the gas pressure. In this case the possible reduction of density turns out adversely even less.

It is known to increase the volume of the foamed parts by increasing the wall size after the injection. This so called “breathing tool” technique is known in many versions. However the described problem remains, i. e. the obtainable reduction of density stays limited.

It is therefore disadvantageous at all pre-known methods of the generic kind that the possible ratio between the end wall thickness and the initial wall thickness is small, if at the same time a strong and light part will be pursued which should have a high surface quality. Dependent on the initial wall thickness, the used polymer and the blowing agent ratios of wall thicknesses of more than two can be obtained rarely.

Thus, it is an object of the invention to develop a method of the generic kind in such a way that it is possible in an easier and more process secure way, to produce light and high-strength plastic parts which have a high surface quality, particularly without flow marks. Thus, foamed and light parts with a compact closed surface should be producible which characterise themselves through a very low density, particularly with less than 0.5 g/cm³.

The solution of this object by the invention is characterized in that the method comprises the steps:
a) Production of thermoplastic melt by rotation of a plasticising screw in a screw cylinder;
b) Adding of a fluid to the thermoplastic melt being located in the screw cylinder by supplying the fluid and/or a chemical component containing the fluid into the screw cylinder;
c) Mixing of the thermoplastic melt containing the fluid by a rotational movement of the plasticising screw;
d) Providing of an injection moulding tool with a cavity, wherein the cavity has walls, wherein the volume of the cavity of the injection moulding tool is expandable from an initial volume to an end volume by relative movement of a part of the tool;
e) Heating of at least a part of the walls of the cavity to a warm temperature;
f) Injection of the mixture from thermoplastic melt and gas into the cavity of the injection moulding tool, wherein the volume of the cavity takes the initial volume;
g) Expansion of the volume of the cavity by relative movement of tool parts;
h) Cooling of at least one part of the walls of the cavity to a cold temperature;
i) Demoulding of the injection moulded plastic part after the plastic melt is at least partially solidified.

The production of thermoplastic melt according above step a) takes place preferably in a combined plasticising and injection unit. However, also the method is not excluded, in which a pre-plasticising unit conveys melt into a melt storage from which the melt is feed into the tool.

The adding of fluid to the thermoplastic melt according above step b) takes place preferably by means for the injection of the fluid at an axial injection position of the screw cylinder, at which position screw channels of the plasticizing screw are arranged at least temporarily. Insofar physical gassing is concerned. But also a chemical gassing of the plastic melt with blowing agents is not excluded which e. g. react chemically at a predetermined temperature and separate gas.

The mentioned warm temperature lies preferably at or above the softening temperature or the glass temperature of the processed plastic material. The warm temperature can also—which is specifically relevant during the processing of part-crystalline plastic materials—lie at least a given temperature difference above the temperature of the moulding tool which is recommended for the processed plastic material; hereby a temperature difference is preferred which is between 40 K to 60 K, in average at 50 K.

Preferably, the end volume of the cavity has at least 150%, preferably at least 300%, of the initial volume of the cavity. Accordingly, much bigger foaming magnitudes are realized than what is possible with the pre-known methods.

Preferably, the complete plastic part has a density which is less than 0.7 g/cm³, preferably less than 0.5 g/cm³.

The complete plastic part has preferably gas bubbles within its inside with a diameter, wherein the diameter of the gas bubbles is in a boundary area of the plastic part (which extends from the outer surface of the plastic part up to 10% of its thickness or width into the inner of the plastic part) at most 50% of the diameter of the gas bubbles in a centre area of the plastic part. The foam structure along the cross section of the part has an integral distribution. The density decreases from the boundary area with practically the density of the compact plastic up to the plastic part centre.

During the procedure of above step g) a fluid, particularly a gas, can be injected into the plastic melt. Hereafter additional gas is injected into the melt to support the wall thickness enlargement. This can occur in the cavity at one or several locations. At obtaining of the end wall size the gas pressure will preferably be extracted again so that the void, which was built previously through the gas injection, fills and foams with foamed plastic. However, the gas pressure can be maintained also during the cooling phase, if certain voids are wanted in the plastic part.

After the procedure of the above step g) and at obtaining of a maximum volume of the cavity, the volume of the cavity can get decreased again, wherein the maximum volume of the cavity is preferably higher than the end volume of the cavity. After this it is beneficial to close the tool a small amount again after its opening (increasing in volume) to improve the contact of the wall for a more intensive cooling.

Before the procedure of the above step f) at least one insert part can be inserted into the cavity of the injection moulding tool, particularly a foil and a reinforcing foil respectively, a knit fabric, a texture, an organo plate and/or a metal plate. Accordingly decorative characters of the part respectively certain mechanic or stability characters can be obtained if said insert are inserted into the cavity.

Thus, it is provided that the temperature of the cavity is warmed and cooled cyclically. It is required for this purpose that the cavity can get energetically favourably and quickly heated up and cooled down. For this, different methods can be applied which are known as such.

At a known method the mould core will be cut into slices, wherein the desired cooling contour for cooling channels will be inserted. After that the slices will be brazed again in the vacuum with the core.

At another method the cores will be established out of metal powder through laser. Thereby, the cooling holes are arranged close to the cavity.

At other methods tools will be established as formed shells which will be linked afterwards and leave a lot of space for the cooling in between.

At another additional method a volume will be milled close underneath of the cavity wall, which will be filled with steel balls for the transmission of the mechanical forces.

As a cooling carrier, water qualifies itself in a particular way.

To heat up the cavity different methods can be applied. The application of superheated steam or—particularly—water which is heated and held under pressure as well as the application of a ceramic heater, a resistance heating or an induction heater is possible.

The cavity surfaces can be heated also through exposure of heat extraneous, like for example by radiation or induction, in an open state of the injection moulding tool. Directly afterwards the tool closes for the injection procedure of plastic melt.

With these methods the heating and the cooling of the cavity wall are performable within seconds.

Reference is made e. g. to DE 10 2008 031 391 A1, which describes a method in which the cavity will be heated within short time by inductive heating.

As defined above the chemically and/or physically gassed plastic melt will be injected into the hot tool. Through the injection into the hot cavity foamed parts without flow marks with good surfaces will be produced.

Because it has to be guaranteed at the large pursued ratios of expansion that the outside part wall stays in contact with the cavity wall, blowing agents are to be used, which build enough high gas pressures. Physical blowing agents are to be applied preferential here.

The plastic melt will be injected as much as possible with low pressure at the injection into the cavity, wherein a complete respectively substantial complete infill takes place with melt containing blowing agent. Because of the high tool temperature the melt creates a smooth surface within the cavity, preferentially without any flow marks.

Because the high tool temperature ceases the shock-like cooling on the tool wall the melt stays molten within the inner part. The high temperature of the tool wall causes an exact forming of the cavity surface. The surface therefore is mechanically smooth and particularly resistant.

Now a slow and controlled increasing of the cavity wall, i. e. of the cavity volume, takes place. Due to the high gas pressure within the inner of the melt and the controlled or feed-back-controlled increasing of the tool wall, the cavity surfaces can be extracted up to the desired dimension without that the part wall detaches itself from the cavity wall and without that bubble formations occur within the inner of the part.

Is the desired wall size obtained, the cooling of the cavity starts.

The cooling can start directly before, with or straight after the melt injection or even to a later instant of time. When with the cooling of the cavity will be started has a substantial influence at the density of the boundary layer, the integral foam distribution, the dimension of the bubbles in the core and the possible ratio of the expansion.

The result is lightly foamed parts with a smooth surface and extremely low density. Also thick-walled light parts can be produced at a very low density.

Because through the opening movement of the tool the pressure of the blowing agent is basically expended within the inner, the parts can be removed already after a short cooling time without that an after-swelling of the parts will be suspected.

With the process parameter the qualities of the surfaces and densities of the produced parts can be influenced and optimised such as type, portion and quantity of the blowing agent, melt temperature, injection time amongst other things as well as the cavity temperature and its temperature course—particularly in association with the velocity of the tool opening.

Foaming ratios of more than 4 (which means the end volume of the cavity is four times bigger as the initial volume) and more are obtainable in practice. For example wall sizes of 2 mm up to 8 mm can get foamed like that or wall sizes of 5 mm up to 20 mm.

Also particularly bending rigid and high-strengthened parts with even larger wall sizes or wall size areas can be obtained.

As a preferential treatment of a constant foam structure within the inner of a part, formable seed crystal can be added such as filler material, chemical blowing agent or others.

Also additives such as fibre glass or other reinforcing substances can be added to the melt which contains blowing agents.

The “breathing action” of the tool doesn't have to go over the whole surface of the cavity wall. It makes sense to let “breath” only sections of the cavity wall. Therefore the part can be changed in its characters if necessary only in particular areas.

Embodiments of the invention are shown in the drawings.

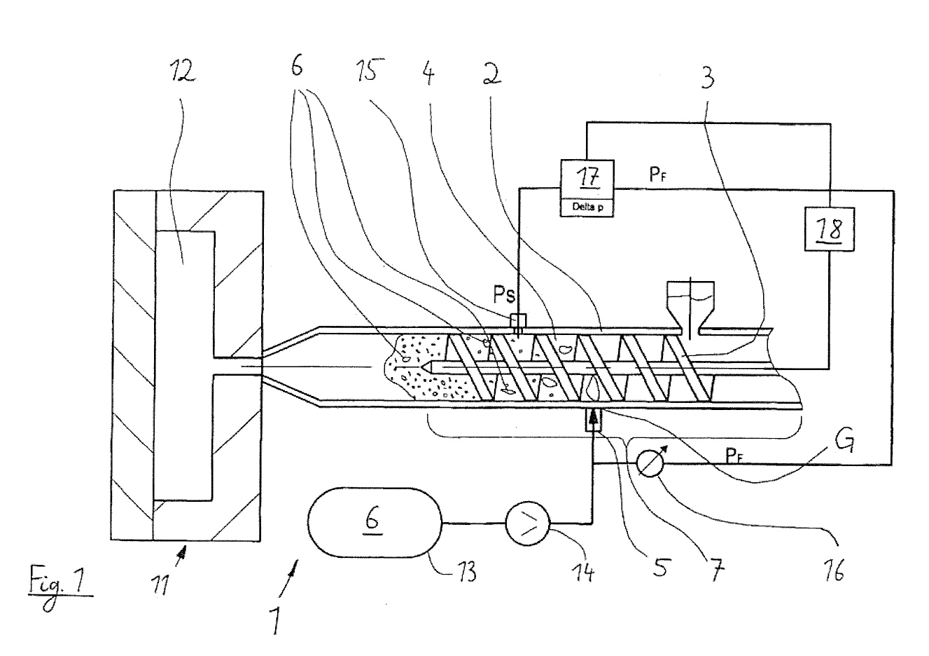

FIG. 1 shows schematically a device for injection moulding.

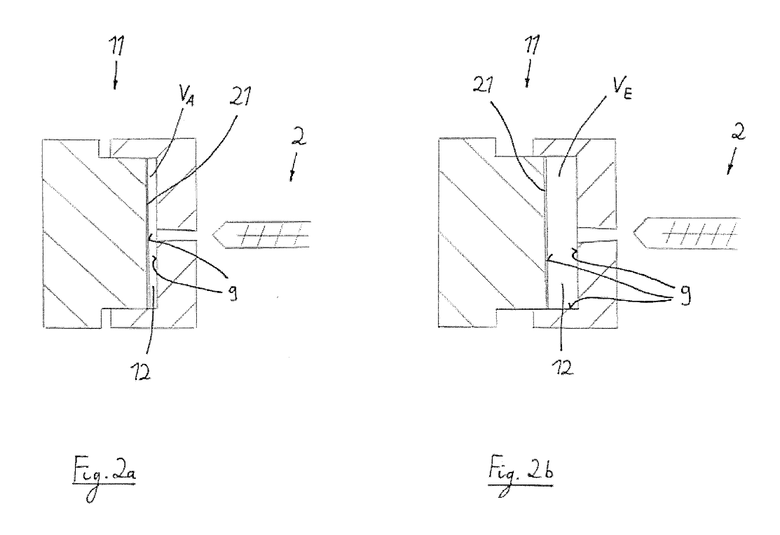

FIG. 2a shows schematically an injection moulding tool according to a first embodiment of the invention, wherein the cavity of the injection moulding tool takes up its initial volume.

FIG. 2b shows corresponding to FIG. 2a the injection moulding tool, wherein the cavity now takes up its end volume.

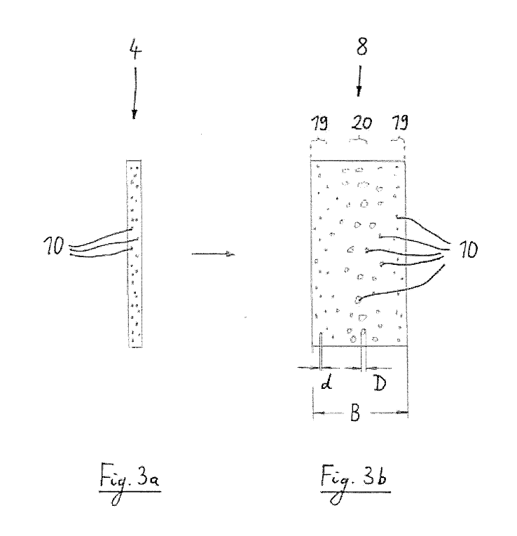

FIG. 3a shows schematically the plastic melt without depiction of the injection moulding tool according to FIG. 2a.

FIG. 3b shows schematically the manufactured plastic part without depiction of the injection moulding tool according to FIG. 2b.

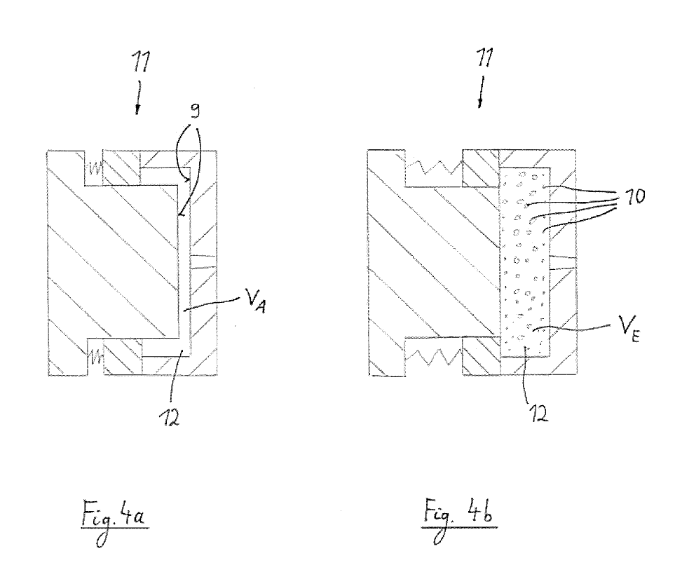

FIG. 4a shows schematically an injection moulding tool according to a second embodiment of the invention, wherein the cavity of the injection moulding tool takes up its initial volume.

FIG. 4b shows corresponding to FIG. 4a the injection moulding tool, wherein the cavity now takes up its end volume.

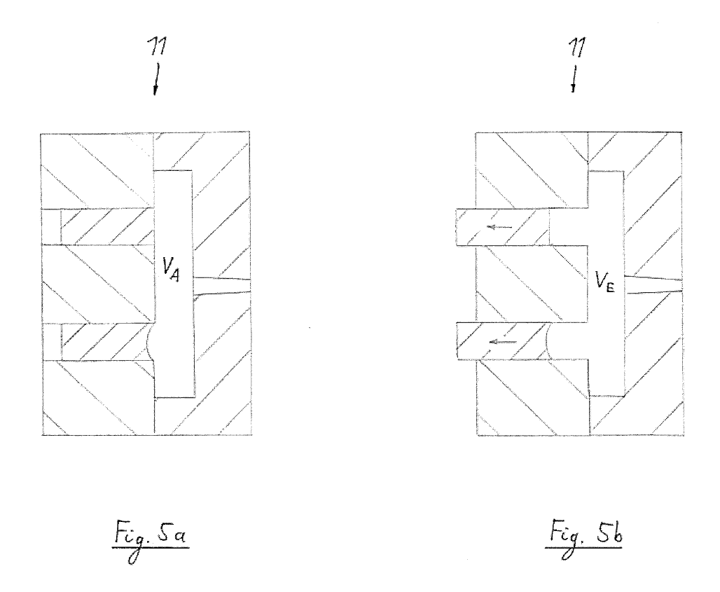

FIG. 5a shows schematically an injection moulding tool according to a third embodiment of the invention, wherein the cavity of the injection moulding tool takes up its initial volume.

FIG. 5b shows corresponding to FIG. 5a the injection moulding tool, wherein the cavity now takes up its end volume.

In FIG. 1 an injection moulding device 1, thus an injection moulding machine, is shown schematically in a stadium, where a melt-gas-mixture is produced. Later the produced plastic melt will be injected into the injection moulding tool 11 (depicted only schematically here) which exhibits a suitable cavity 12. A plasticizing- and injection screw 3 is arranged rotatable and axially movable in the screw cylinder 2. In order to the production of thermoplastic plastic melt 4 the screw 3 rotates first without axial movement in the screw cylinder 2.

Fluid in the form of a gas 6 is stored in a storage tank 13. It will be added to a compressor 14 which brings it to a desired pressure. From the compressor 14 the gas reaches over a conduit to means 5 for the injection of gas that is to say to an injection nozzle which is attached to the screw cylinder. A volume control device is not shown with, by which the volume of the injected gas can be feed-back-controlled according to a given value. Through the nozzle 5 the gas 6 can be controlled respectively feed-back-controlled be injected into the screw cylinder 2 and therefore into the plastic melt 4. This certainly only works out then when the gas pressure p_{F} is higher than the gas in the melt p_{S}, which means that the difference of the pressure between the pressure in the gas and the plastic melt Delta p=p_{F}−p_{S} has to be positive.

The gasing of the gas 6 over the nozzle 5 occurs at an axial injection position G where the screw channels 7 of the screw 3 stand, at least temporary, namely during plasticizing of the melt.

If enough melt-gas-mixture is produced for a shot, the mixture can be injected into the cavity 12 of the injection moulding tool 11 by an axial movement of the screw, which is not displayed.

For establishment of a stable injection moulding process will make sure that the difference of the pressure Delta p stays extensively constant, at least within a given tolerance range which can be for example 2 bar. The device is therefore equipped with a pressure sensor 15 for measuring the pressure p_{S} in the melt 4, with a pressure sensor 16 for measuring of the gas pressure p_{F} as well as with a device for determining a difference 17 for the determination of the pressure difference Delta p=p_{F}−p_{S}. The measured pressure difference will be fed to the control 18 of the injection moulding machine which takes care, according to a program, that this value stays within a given tolerance range.

As a possible intervention those injection moulding parameter serve that are known to the man skilled in the art, for example the revolution speed of the screw and the axial force at the injection of melt. It is obvious that a reduction of the injection force reduces the melt pressure whereat an intervention is possible. Otherwise also the gas pressure p_{F} and/or the gas volume can be controlled accordingly to keep the desired pressure difference Delta p.

Instead of a gas basically another fluid, such as a liquid, can be added to the melt.

Through the addition of gas it will be obtained that a part out of a plastic-gas-mixture will be produced which doesn't exhibit any shrink marks and which has a foam structure in its inner. For this reason particularly large foamed plastic parts such as panels and parts with three-dimensional geometry can be produced on a safe process and economically also with different wall sizes and ribbings.

To prevent a premature foaming of the plastic-gas- or plastic-liquid-mixture in the cavity a counter pressure in the cavity can be built before the injection of the mixture which will be consumed only little by little with the entrance of the mixture; a gas cushion will be subtended to the melt flow front. The foaming can be controlled respectively feed-back-controlled through that.

In FIG. 2 an injection moulding tool 11 is shown according to a first concrete embodiment of the invention. Two relatively movable tool parts aren't only responsible for the opening and the closing of the tool but also obtains that the volume of the cavity 12 is changeable in dependence of the relative position of the two tool parts also. In FIG. 2a a small initial volume V_{A} exists which has been increased through “breathing” of the one tool part according to FIG. 2b onto the higher end volume V_{E}. Accordingly two walls 9 of the cavity that lie across from each other will be driven apart after that the plastic melt resides in the cavity 12.

Not displayed in FIG. 2 is, that the tool 11 is added with means by which the cavity walls 9 can get heated up quickly and also cooled down to carry out the method described above.

To mention according to FIG. 2 is also to the solution that an insert part 21 was placed in the cavity 12 before the injection of the plastic melt 4, which will be connected in situ with the plastic melt 4 through the injection moulding method.

The insert part 21 will be positioned respectively inserted into the opened tool. It either can serve as decorative purposes or can influence particular characters in a desired manner such as surface hardness, stiffness or other characters. The insert parts can be inserted of course on both respectively several sides of the cavity—in contrast to the drafted solution.

Insert parts being GF- or CF-mats, organo plates, metal plates or other insert parts particularly are planed which produce a higher stiffness and stability of the parts than as the foamed parts could do themselves.

The comparison with FIG. 3a—where the plastic melt 4 is demonstrated which is injected into the cavity 12 with its insert volume—with FIG. 3b—where the plastic part 8 is demonstrated after that the cavity 12 was advanced onto the end volume V_{E}—shows how small gas bubbles 10 have increased first in the plastic melt 4 because of the described process at warm wall 9 of the cavity 12 and the “breathing core” considerably though in such a way that the gas bubbles 10 increased their volume only in the inner of the parts.

This means precisely that in a boundary area 19 of the part 8 (which extends the most 10% of the thickness or width extension B of the part 8) the average diameter d of the gas bubbles 10 conducts only at most 50% of the diameter D of the gas bubbles 10 in a central centre area 20.

Fine cellular foam exists. Furthermore an integral structure is given with little cells in the proximity of the part surface and larger cells in the middle of the part what can be beneficial also in consideration of the stability behaviour.

In the FIGS. 4a and 4b an embodiment is depicted where just an area of it “breathes” and not the whole cavity surface (which means wall 9), i. e. which effects the enlargement of the cavity volume.

It can be seen from the solution according to FIGS. 5a and 5b that two movable tool cores of different geometry are intended—according to a further embodiment of the invention. Herewith further possibilities will be opened to influence the part geometry. Thereby also the density of the basic wall can get changed of course.

The above mentioned warm temperature depends on a preferred method of the recommended tool temperature and will be determined on a defined temperature difference, for example of 50 K, on which the cavity walls of the tools will be heated up before the injection of the melt. During the process of ABS the recommended tool temperature lies between 50° C. up to 80° C. for example, so that in this case a warm temperature will be pursued of approx. 100° C. up to 130° C.

### List of References

1 Injection moulding device

2 Screw cylinder

3 Plasticising and injection screw

4 Plastic melt

5 Means for the injection of gas

6 Fluid (gas)

7 Screw channel

8 Plastic part

9 Wall

10 Gas bubble

11 Injection moulding tool

12 Cavity

13 Storage tank

14 Compressor

15 Pressure sensor for melt

16 Pressure sensor for gas

17 Device for determining a difference

18 Control/Feed-Back-Control

19 Boundary area

20 Center area

21 Insert part

G Injection position for gas

V_{A} Initial volume

V_{E} End volume

T_{W} Warm temperature

T_{K} Cold temperature

d Diameter of the gas bubble

D Diameter of the gas bubble

B Thickness or Width

P_{F} Gas pressure

P_{S} Melt pressure

Delta p Pressure difference: p_{F}−p_{S}

1. Method for the injection moulding of plastic parts from thermoplastic material, comprising the steps:
a) Production of thermoplastic melt by rotation of a plasticising screw in a screw cylinder;
b) Adding of a fluid to the thermoplastic melt being located in the screw cylinder by supplying the fluid and/or a chemical component containing the fluid into the screw cylinder;
c) Mixing of the thermoplastic melt containing the fluid by a rotational movement of the plasticising screw;
d) Providing of an injection moulding tool with a cavity, wherein the cavity has walls, wherein the volume of the cavity of the injection moulding tool is expandable from an initial volume to an end volume by relative movement of a part of the tool;
e) Heating of at least a part of the walls of the cavity to a warm temperature;
f) Injection of the mixture from thermoplastic melt and gas into the cavity of the injection moulding tool, wherein the volume of the cavity takes the initial volume;
g) Expansion of the volume of the cavity by relative movement of tool parts;
h) Cooling of at least one part of the walls of the cavity to a cold temperature;
i) Demoulding of the injection moulded plastic part after the plastic melt is at least partially solidified.

2. Method according to claim 1, wherein the production of thermoplastic melt according step a) takes place in a combined plasticising and injection unit.

3. Method according to claim 1, wherein the adding of fluid to the thermoplastic melt according step b) takes place by means for the injection of the fluid at an axial injection position of the screw cylinder, at which position screw channels of the plasticizing screw are arranged at least temporarily.

4. Method according to claim 1, wherein the warm temperature lies at or above the softening temperature or the glass temperature of the processed plastic material or that the warm temperature lies at least a given temperature difference, preferred at 40 K to 60 K, above the temperature of the moulding tool which is recommended for the processed plastic material.

5. Method according to claim 1, wherein the end volume of the cavity is at least 150%, preferential at least 300%, of the initial volume of the cavity.

6. Method according to claim 1, wherein the complete plastic part has a density which is less than 0.7 g/cm³, preferential less than 0.5 g/cm³.

7. Method according to claim 1, wherein the complete plastic part has gas bubbles within its inside with a diameter, wherein the diameter of the gas bubbles is in a boundary area of the plastic part at most 50% of the diameter of the gas bubbles in a centre area of the plastic part, wherein the boundary area extends from the external surface of the plastic part up to 10% of a thickness or width into the inside of the plastic part.

8. Method according to claim 1, wherein during the procedure of step g) a fluid, particularly a gas, is injected into the plastic melt.

9. Method according to claim 1, wherein after the procedure of step g) and the achievement of a maximum volume of the cavity the volume of the cavity is reduced again, wherein the maximum volume of the cavity is preferential bigger than the end volume of the cavity.

10. Method according to claim 1, wherein previous to the procedure of step f) at least one insert part is inserted into the cavity of the injection moulding tool, particularly a foil, a knit fabric, a texture, an organo plate and/or a metal plate.
